(19) United States
(12) Patent Application Publication
(10) Pub. No.: US 2014/0243028 A1
(43) Pub. Date: Aug. 28, 2014

(54) ENHANCED TEXT MESSAGING SERVICE

(71) Applicants: Michael J. Colombo, Melrose, MA (US); Rich Wagner, Princeton, MA (US)

(72) Inventors: Michael J. Colombo, Melrose, MA (US); Rich Wagner, Princeton, MA (US)

(21) Appl. No.: 14/189,675

(22) Filed: Feb. 25, 2014

Related U.S. Application Data
(60) Provisional application No. 61/768,912, filed on Feb. 25, 2013.

(51) Int. Cl. H04W 4/12

(52) U.S. Cl. CPC H04W 4/12
USPC 455/466

(57) ABSTRACT

Illustratively, and not by way of limitation, in one embodiment a software client supports basic rich communication suite (RCS) chat capabilities, wherein a user's chat/text message is sent to both an RCS chat server as well as a smart text services (STS) server. The STS server acquires tagged terms (e.g., “#movie-title”) and retrieves relevant information (e.g., showtimes, locations, reviews, ticket purchases, etc.). When a match is found (e.g., at the selection of the sender), the user interface integrates Smart Text results in a dedicated container (panel) to display the match and relevant actions to a receiver (e.g., and sender) of the message.

### RELATED APPLICATION

The present application claims priority to U.S. Provisional Application No. 61/768,912, filed Feb. 25, 2013, entitled: ENHANCED TEXT MESSAGING SERVICE, by Colombo et al., the contents of which are herein incorporated by reference.

### TECHNICAL FIELD

The present invention relates generally to text messaging services, and, more particularly, to enhanced user features in text messaging.

### BACKGROUND

A communication device such as a cell phone may be able to communicate with one or more other devices through a cellular network of a carrier with which the user of the device has an account. A variety of different types of services may be offered by the carrier to this end, including services that permit a messaging service message (e.g., Short Message Service (SMS), Multimedia Messaging Service (MMS), and Rich Communication Suite (RCS) service) to be transmitted from/to the device through the carrier's cellular network. Other messaging services, such as Internet-based services (e.g., proprietary protocols), also allow users to communicate messages between each other.

Generally, such “text messages” may include text only, text-based images, attached photos/videos, and/or links (e.g., universal resource locators, or URLs) to online content. As messaging products evolve, it is desirable for wireless carriers to provide enhanced functionality so that users can enjoy the simplicity of text messages, while still having the ability to interact in a content-rich manner.

### SUMMARY

According to one or more embodiments of the invention, a specific tagged content or identified content may be detected within a text message, which either during composition of the message or in response to sending of the message results in calling up sender selection of rich content associated with the tagged or identified content. As such, the selected rich content may be embedded into the text message, for instance, as a hyper-link, or as an embedded panel/display, etc., as related to the rich content.

For example, in one embodiment a software client supports basic rich communication suite (RCS) chat capabilities, wherein a user's (drafter's) chat/text message is sent to both an RCS chat server as well as a smart text services (STS) server. The STS server acquires tagged terms (e.g., “#movie-title”) and retrieves relevant information (e.g., showtimes, locations, reviews, ticket purchases, etc.). When a match is found (e.g., at the selection of the sender), the user interface integrates Smart Text results in a dedicated container (panel) to display the match and relevant actions to a receiver (e.g., and sender) of the message.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication network;

FIG. 2 illustrates an example computing device;

FIG. 3 illustrates an example simplified procedure for an enhanced text messaging service;

FIG. 4 illustrates an example of a compose mode of an enhanced text messaging service;

FIGS. 5A-5C illustrate an example of a parallel mode of an enhanced text messaging service;

FIG. 6A-6B illustrate another example simplified procedure for an enhanced text messaging service;

FIGS. 7A-7H illustrate an example of an enhanced text messaging service communication; and

FIGS. 8A-8B illustrate an additional example of an enhanced text messaging service.

### DETAILED DESCRIPTION OF EXAMPLE EMBODIMENTS

Particular embodiments may operate in, or in conjunction with, a communication network environment, such as a cellular network, the Internet, etc., including multiple network addressable systems (e.g., phone numbers, Internet Protocol (IP) addresses, etc.).

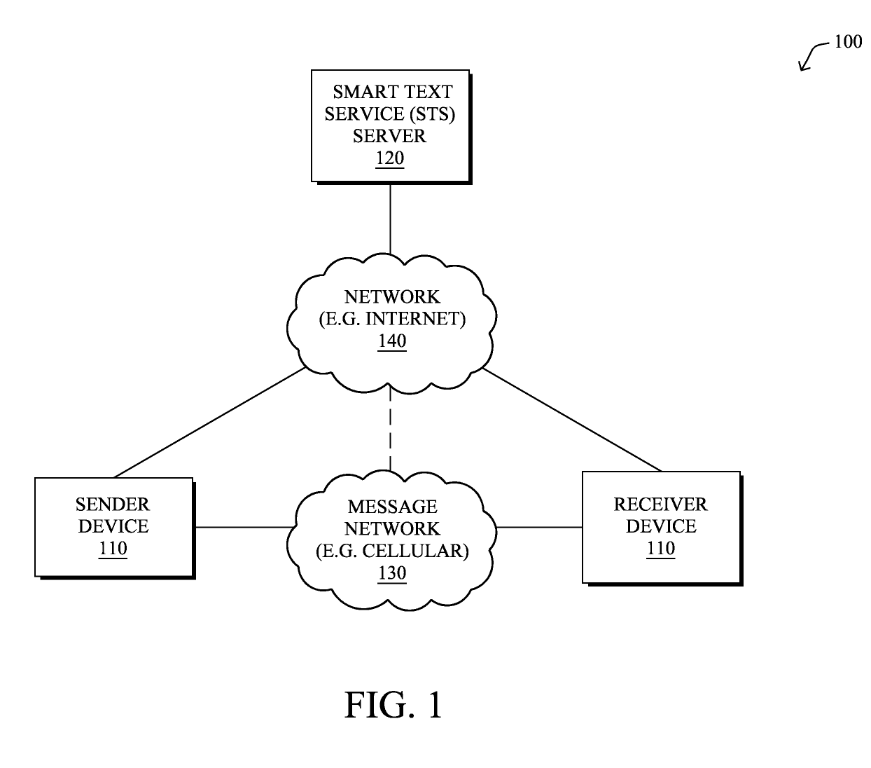

FIG. 1 illustrates an example communication environment 100, in which various example embodiments may operate. Various client devices 110 may be in communication with each other within the network 100, such as mobile devices (e.g., phones, tablets, automobiles, etc.) or stationary devices (e.g., personal computers, desktops, etc.). Illustratively, such communication may be via a “messaging network”, such as a cellular telephone network 130, and/or a separate or associated Internet network 140 (e.g., a WiFi network, wide area network, etc.), as described herein. One or more servers 120 (e.g., websites, databases, etc.) may also be in communication within the network 100, as also described herein. Notably, the network clouds 130/140 generally represent one or more interconnected networks, over which various systems and hosts described herein may communicate, and may comprise packet-based wide area networks (such as the Internet), private networks, wireless networks, satellite networks, cellular networks, paging networks, and the like, and the view shown herein is merely illustrative.

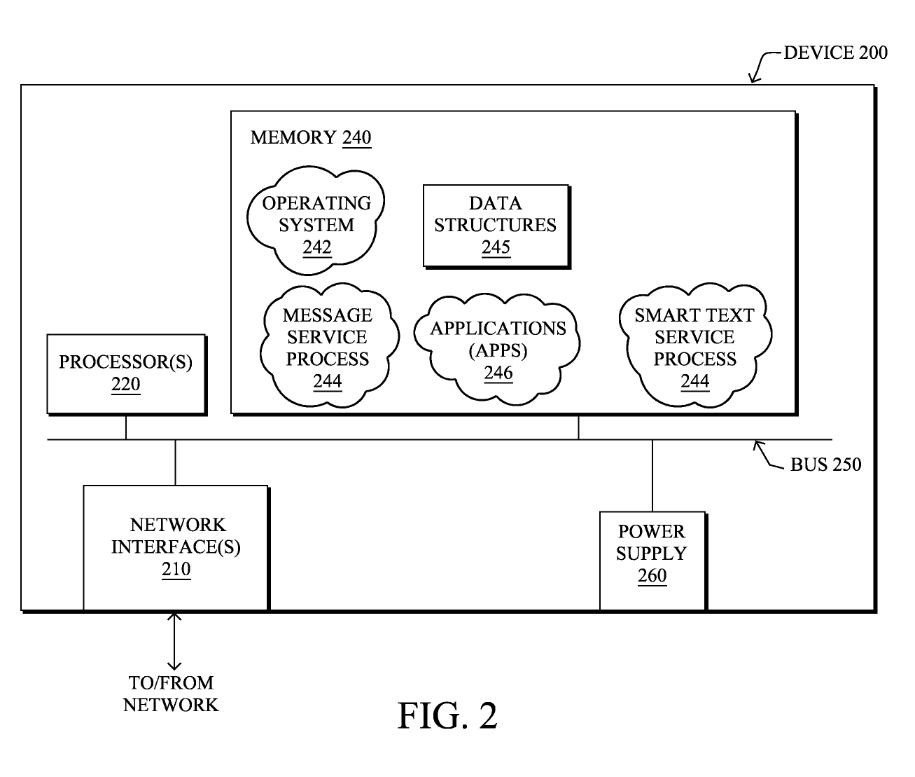

Generally, the client devices 110 and servers 120 of FIG. 1 may be operably connected to the network environment 100 via a network service provider, a telephone service provider, a wireless carrier, or any other suitable means. Each client device and/or server may generally be a computer, computing system, or computing device including functionality for communicating (e.g., remotely) over a computer network. FIG. 2 is a schematic block diagram of an example device 200 that may be used with one or more embodiments described herein, e.g., as any of the client devices 110 and/or servers 120 shown in FIG. 1 above. The device may comprise one or more network interfaces 210 (e.g., cellular, wireless/WiFi, etc.), at least one processor 220, and a memory 240 interconnected by a system bus 250. Also, a power supply 260 (e.g., battery, plug-in, etc.) may also supply power to the device 200.

The network interface(s) 210 contain the mechanical, electrical, and signaling circuitry for communicating data over links coupled to the network 100 (e.g., networks 130 and/or 140). The network interfaces may be configured to transmit and/or receive data using a variety of different communication protocols. Note, further, that the nodes may have two different types of network connections 210, e.g., wireless and cellular (or even wired/physical connections), and that the view herein is merely for illustration.

The memory 240 comprises a plurality of storage locations that are addressable by the processor 220 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, inter alia, invoking operations in support of software processes and/or services executing on the device. These software processes and/or services may comprise a messaging service process 244, one or more applications or “apps” 246, and an illustrative “smart text service” (or STS) process 248, which may be configured depending upon the particular device within the network 100 (e.g., as a client device 110 or as a server 120), as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Messaging service process 244 contains computer executable instructions executed by the processor 220 to perform functions provided by one or more messaging (text messaging) protocols, as will be appreciated by those skilled in the art. For example, such text messaging may be embodied as a Short Message Service (SMS), Multimedia Messaging Service (MMS), a Rich Communication Suite (RCS) service, APPLE INC's iMessage service, etc., as well as various “over-the-top” messaging services (e.g., SKYPE messaging, FACEBOOK messaging, etc.). Also, the applications (apps) 246 may comprise one or more specific and/or integrated applications, such as a web browser to access and view content over the network 100 (e.g., MICROSOFT WINDOWS INTERNET EXPLORER, MOZILLA FIREFOX, APPLE SAFARI, GOOGLE CHROME, etc.). Other specific apps may comprise such feature-specific applications such as music apps, consumer product purchasing apps, restaurant review/reservation apps, movie apps (e.g., for purchasing tickets, reading reviews, etc.), and so on.

In particular implementations, the client applications, particularly the web browser, allow a user of client device to enter addresses of specific network resources to be retrieved, such as resources hosted by a social network environment, web application servers, or enterprise servers. These addresses can be Uniform Resource Locators (URLs). In addition, once a page or other resource has been retrieved, the client applications may provide access to other pages or records when the user “clicks” on hyperlinks to other resources. By way of example, such hyperlinks may be located within the web pages and provide an automated way for the user to enter the URL of another page and to retrieve that page. Furthermore, as will be readily understood by those skilled in the art, an app may also provide a user interface (e.g., a graphical user interface or “GUI”) that can be used by users (clients) for interaction and access.

As noted above, as messaging products evolve, it is desirable for wireless carriers to provide enhanced functionality so that users can enjoy the simplicity of text messages, while still having the ability to interact in a content-rich manner. The techniques described herein provide an enhanced text messaging service that detect a specific tagged content or identified content within text message, which either during composition of the message or in response to sending of the message results in calling up sender selection of rich content associated with the tagged or identified content. As such, the selected rich content may be embedded into the text message, for instance, as a hyper-link, or as embedded panel/display, etc., as related to the rich content.

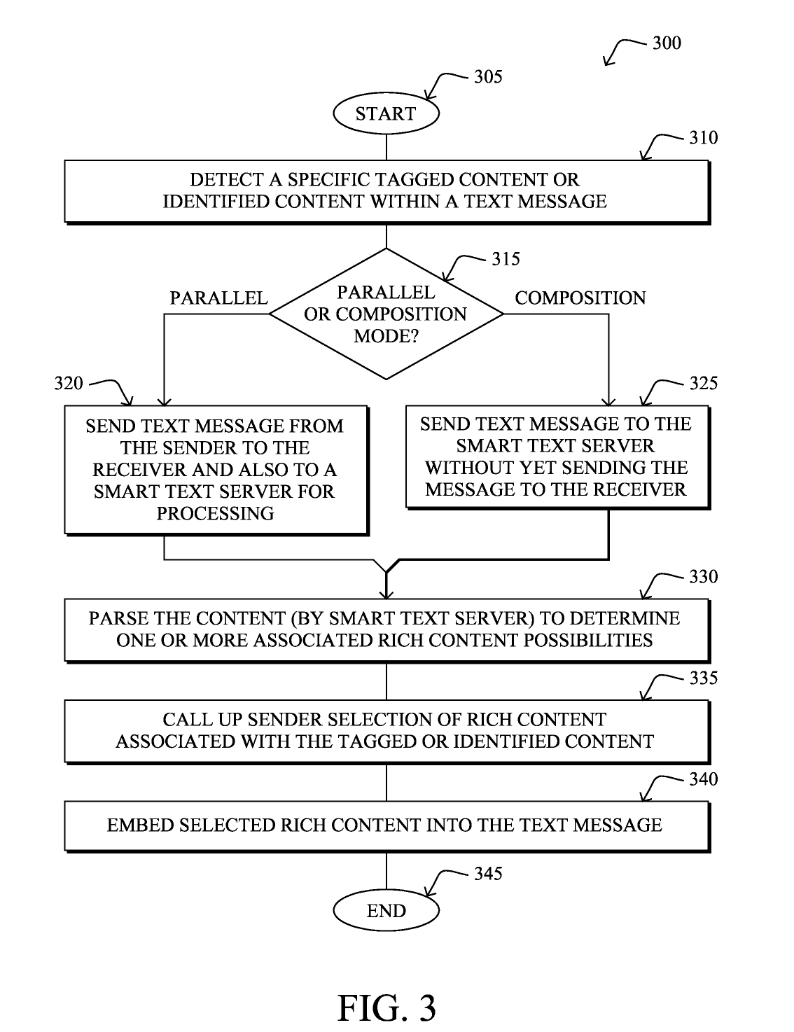

In particular, as a brief introduction, FIG. 3 illustrates an example simplified procedure 300 for an enhanced text messaging service in accordance with one or more embodiments described in greater detail below. The procedure 300 starts at step 305, and continues to step 310, where a specific tagged content or identified content is detected within a text message. If in step 315 the embodiment is operating in parallel mode, then in step 320 the text message may be sent from the sender to the receiver, and also to a smart text server (e.g., server 120) for processing. If, however, in step 315 the embodiment is in composition mode, then in step 325 the text message (or simply the tagged or identified content) is sent to the smart text server without yet sending the message to the receiver. The server 120 may then parse the content in step 330 to determine one or more associated rich content possibilities, such as based on context, key words, trending ideas, geo-location of the sender (and/or receiver), etc. For example, as described below, a text message asking “Do you want to see #movie-title?” could bring up showtimes, locations, ticket purchasing options, reviews, trailers, etc. As such, in step 335, sender selection of rich content associated with the tagged or identified content may be called up, such as asking the sender to confirm which rich content is relevant and/or which rich content is desired for inclusion (e.g., showtimes and locations, but not ticket options, reviews, or trailers). As such, in step 340, whether when sending the text message for the first time (compose mode), or by editing or appending to the content previously sent (parallel mode), the selected rich content may be embedded into the text message, for instance, as a hyper-link, or as embedded panel/display, etc., as related to the rich content, as described in greater detail below. The illustrative procedure 300 may then end in step 345, where the receiver (and/or sender) has the option to view the rich content, either through an embedded panel on the receiver's (and/or sender's) text message display, or by clicking on a provided link to reach one of either a pre-generated web-page dedicated to the particular sender-selected rich content (e.g., specifically designed/created by server 120 based on the sender-selected content) or else to a more general web-page related to the content (e.g., a third-party web-page selected by the server 120).

Illustratively, the techniques described herein may be performed by hardware, software, and/or firmware, such as in accordance with the smart text service (STS) process 248, which may contain computer executable instructions executed by the processor 220 to perform functions relating to the techniques described herein, e.g., optionally in conjunction with other processes/apps/services. For example, certain aspects of the techniques herein may be treated as extensions to conventional messaging protocols 244, and as such, may be processed by similar components understood in the art that execute those protocols, accordingly.

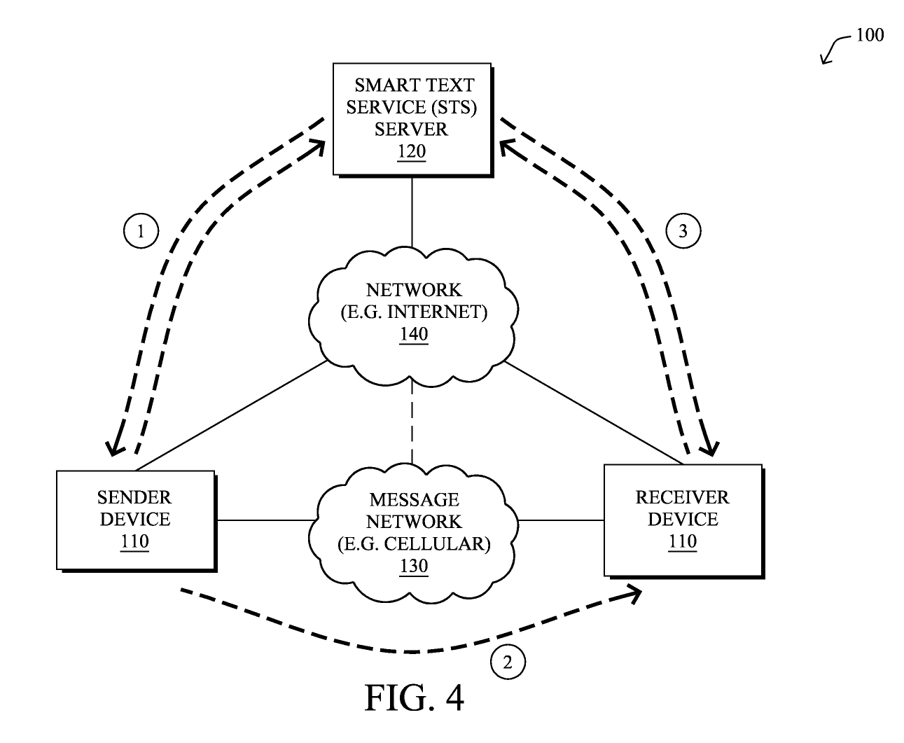

Operationally, a smart text service (STS) client (process 248) executes on at least the sender's device 110 (e.g., APPLE iPhones, GOOGLE Android devices, computers running SKYPE, etc.) and monitors one or more text messaging applications for tagged content or identified content within given contexts. As illustrated in FIG. 4 (showing a “compose” or “composition” mode of operation), the sender device may communicate the tagged content and/or identified content to the STS server 120 (“1”), which may then convert the content into rich content based on the associated context. For example, as described herein, “tagged content” may be a word or phrase that is preceded, succeeded, or surrounded by one or more identifying characters or hashtags, such as #, %, ̂, *, etc. “Identified content,” on the other hand, is content that is associated with keywords and/or contextual words, such as “listen to this song” or “let's eat at Luigi's”, where “listen” and “song” can be contextually inferred to imply a given media-based song entry, while “eat” and “Luigi's” can be contextually inferred to imply going to dinner at a restaurant named “Luigi's” (e.g., within the surrounding area of one or both of the communicators). Other words may comprise various words such as “read”, “watch”, “go see”, “buy”, “want”, and so on.

In addition, certain words or phrases, whether tagged or not, may be recognized or reserved words/phrases that imply a special meaning, such as “#hereiam” (here-I-am) to pinpoint and share the sender's current geo-location (e.g., an approximate address on a street map), or “#currentvenue” to pinpoint and share the sender's current venue location (e.g., a venue name, information, reviews, and address on a map). Notably, the reserved words or “smart tags” used herein are merely examples, and any words or phrases may be configured, and the words/phrases illustrated herein may even be used for different purposes as designed by implementers of the techniques herein, as may be readily appreciated by those skilled in the art.

If any tagged or identified content is detected by the client device, then the text message (or at least the tagged or identified content) may be sent to the server 120 for further processing, e.g., using a natural language parser or other techniques. Alternatively, all text messages may be passed through the server, and the server 120 may be configured to detect tagged content and/or to identify content within given contexts.

Once at the server, a context and relevancy analyzer engine (e.g., a component of STS process 248 on the server 120) may determine the best possible match (rich content options) of the content based on a variety of factors associated with relevancy and context. For instance, various categories of searching may comprise, e.g., consumer goods/product searches (reviews and purchase options), books (reviews, excerpts, and purchase options), songs (preview clips and purchase options), restaurants (reviews, locations, local restaurants based on categories, menus, reservations, etc.), movies (trailers, reviews, playing theaters, showtimes, ticket purchase options, etc.), and so on. Notably, in one embodiment, the searching of content may be limited to a narrowed list for relevance, such as only currently released movies, bestselling books, local restaurants, etc. Also, other factors may be considered for relevance, such as geo-location, current trends, context of remaining message and/or conversation, history of the sender, a planned travel route and/or destination, paid advertisements, etc.

As part of communication channel “1” in FIG. 4, the server 120 may request (“call up”) user selection from the sender regarding the content/context, such as to confirm the sender's intent (e.g., a shared book-title and movie-title could imply either the book or movie, respectively). Also, user selection may be made in the event that multiple possible matches are found, for example, showing the multiple matches in a manner that allows the sender to view them (e.g., cycle through them) to select one or more matches to share with the receiver. For instance, in addition to the example of selecting the book rather than the movie of a shared title, the sender may also be asked to select various restaurants within a category to share, or various categories to share, or various movie-related features, such as showtimes and locations, but not purchasing tickets, and so on.

Once the content and context have been determined, the server may create “rich content”, such as images, links to products, user-friendly displays of information (e.g., movie-related displays showing video trailers, star ratings, nearby theaters, etc.), links to audio/media files for songs, maps, etc. For example the server 120 may access one or more third party APIs (application programming interfaces) depending upon the content and context, such as various well-known product purchasing APIs (e.g., AMAZON.COM), music/media APIs (e.g., APPLE iTUNES), restaurant ratings, reviews, and reservation APIs (e.g., YELP and/or OPENTABLE), map APIs (e.g., GOOGLE MAPS), movie APIs (e.g., ROTTEN-TOMATOES, IMDB.COM, etc.), among others. In this manner, “smart actions” may be generated specific for each type of smart text item, such as aggregating for movies a listing of showtimes, trailers, review, theater locations, ticketing options, etc., while for songs showing an album cover, lyrics, musical preview, music video, and MP3 purchase options. Notably, the smart actions may be specific to the server 120, or may be configured for interaction/integration with other apps 246 operating on the sender's or receiver's device (e.g., music apps, online store apps, etc.).

The “rich content” may then be returned to the sender for embedding into the text message sent to the receiver (communication “2”), generally via the messaging network 130 (e.g., according to whichever message transport service corresponds to the messaging application at use by the sender and/or receiver). The rich content may illustratively take the form of a hyper-link, a “panel” display, images, a URL link to a web-page dedicated to the current rich content, etc., as described herein. In other words, the rich content may take the form of embedded material or a link to the material (e.g., appending a URL to the tagged content, such as “#movie-title[URL]”), depending upon configuration and/or device capability.

Upon receiving the text message with the rich content, the receiver can then see and select (click) the content to be directed externally, such as back to the server 120 (communication “3”) to receive the content in the manner intended by the sender (e.g., seeing the movie trailer and showtimes of a given movie at a particular theater selected by the sender).

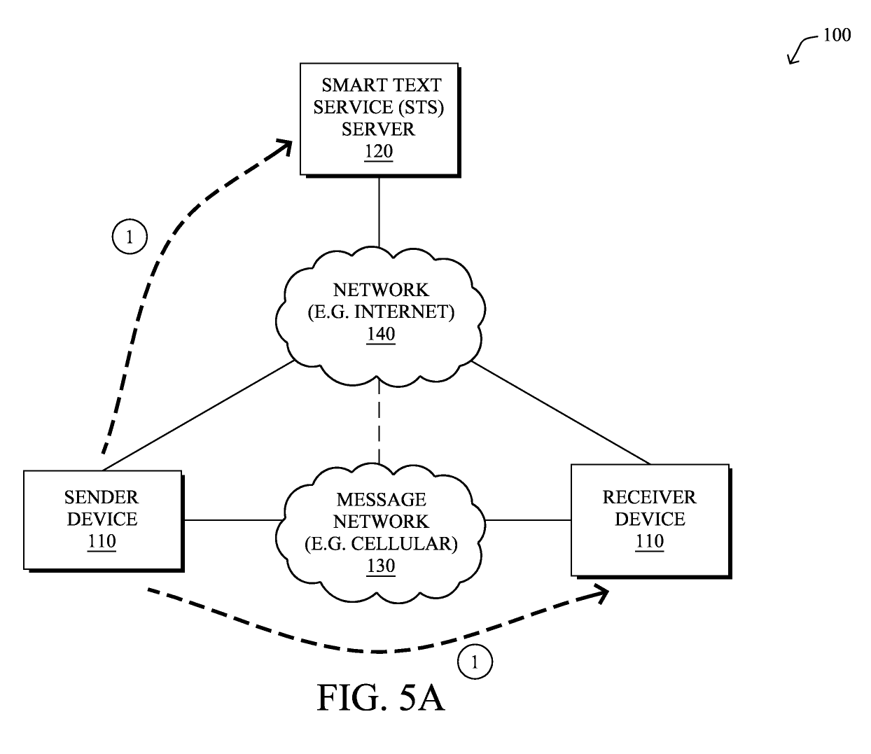

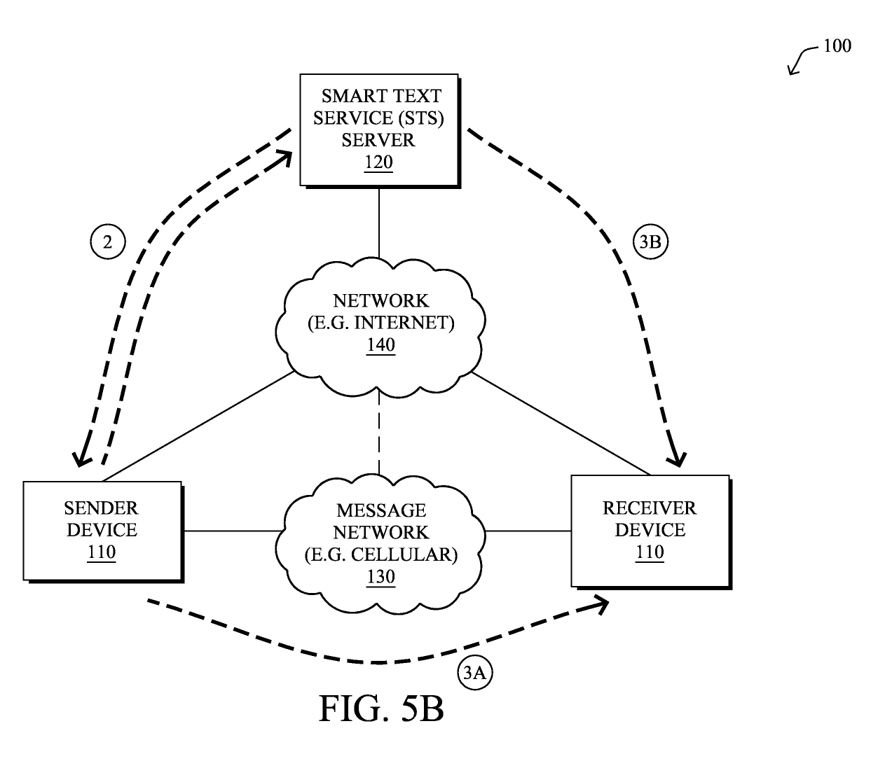

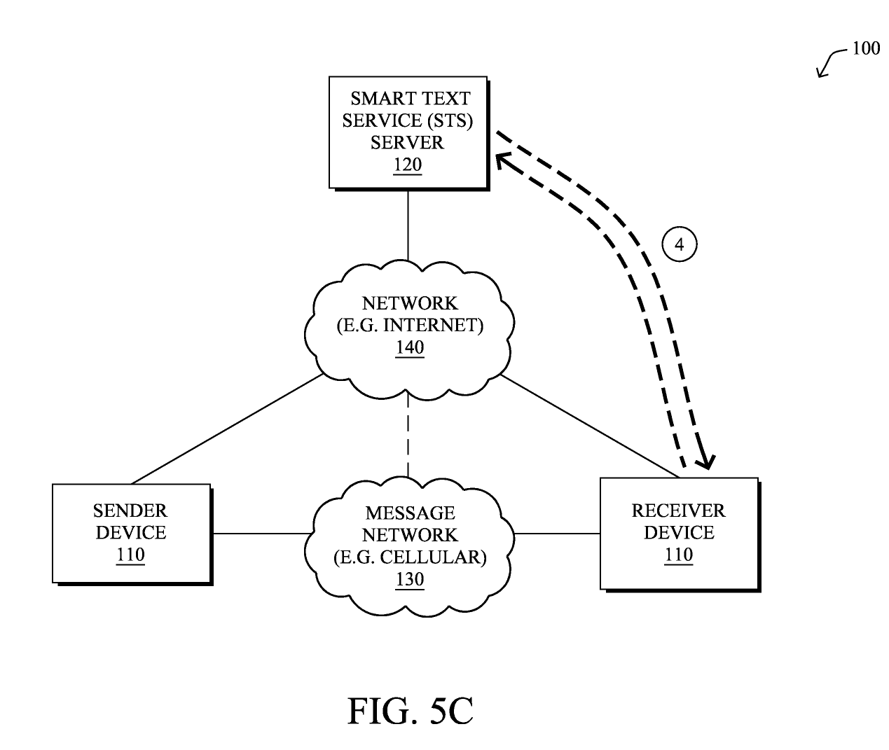

As mentioned, FIG. 4 represents one example implementation referred to as “compose” or “composition” mode, where the sender interacts with the server 120 prior to sending the rich content text message to the receiver. Alternatively, FIGS. 5A-5C illustrate an example of a “parallel” mode of operation, where the initial text message with tagged or possibly identifiable content is sent to both the receiver (e.g., via a text message server, such as an RCS server within network 130), and also to the smart text service (STS) server 120, illustratively via network 140, as shown in FIG. 5A (communication “1”). Then, in FIG. 5B, communication “2” may occur between the sender and the server 120 to focus the search results, which may then either be conveyed from the sender to the receiver via the text communication network 130 (communication “3A”), or else directly to the receiver from the server 120 (communication “3B”). At this time, as in FIG. 5C (communication “4”), the receiver's text message app may either update or append the rich content from the server 120, allowing the receiver to partake in the content as intended by the sender.

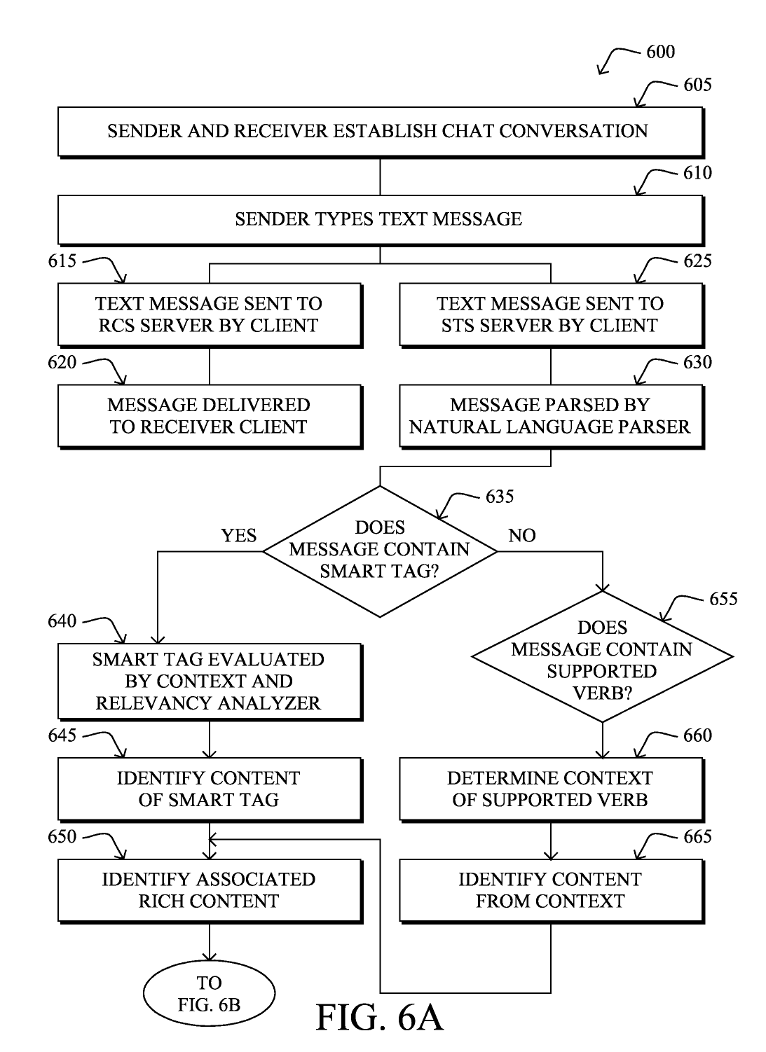

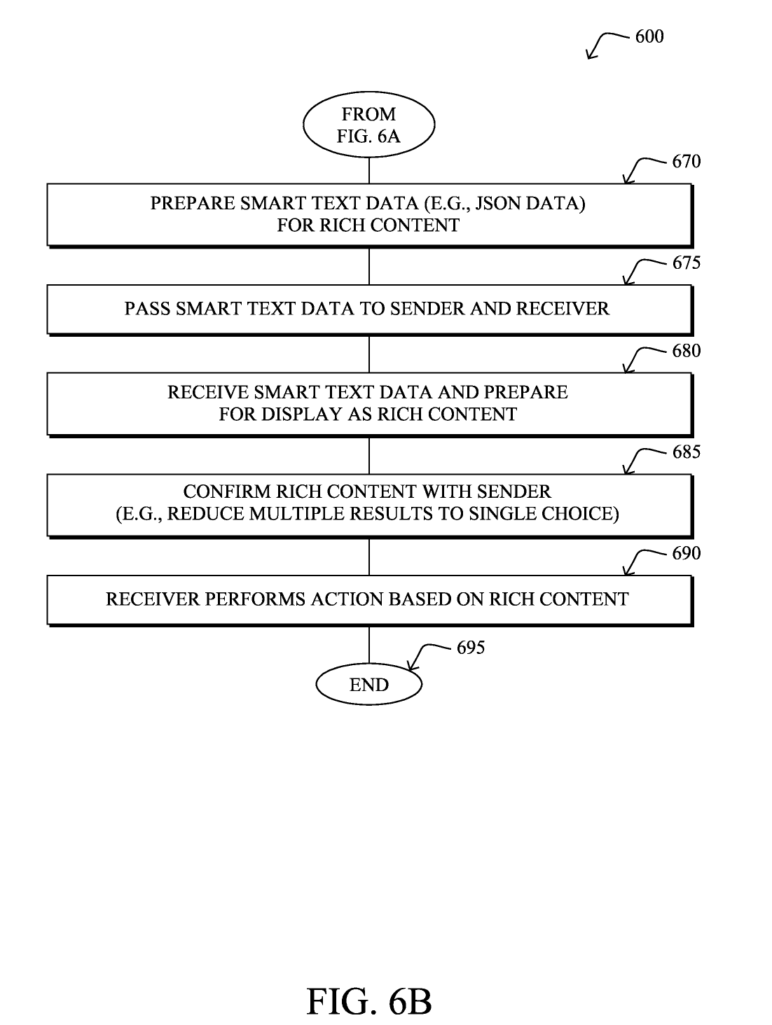

FIGS. 6A-6B illustrate another example simplified procedure 600 for an enhanced text messaging service in accordance with one or more embodiments described herein, such as in relation to a book scenario, a song scenario, and a restaurant scenario. The procedure 600 starts at step 605, where the sender and receiver (devices 110) establish a chat conversation, and the sender types a text message in step 610. For example, the sender may type any of the following options:
“Have you read #book-title#?” (Book scenario A);
“Have you read book-title?” (Book scenario B);
“#Song-title# is my new favorite tune” (Song scenario A);
“Listen to song-title, my new favorite” (Song scenario B);
“Want to go to #restaurant-name#?” (Restaurant scenario A); or
“Want to eat Italian?” (Restaurant scenario B).

In parallel mode, as an example, the text message is sent to the RCS server by the client in step 615, and then delivered to the receiver client in step 620. At the same time, in step 625 the text message is also sent to the RCS server (server 120) by the client, and the message is illustratively parsed by a natural language parser in step 630.

If in step 635 the message contains a smart tag (as described herein, notably scenario A above for each type), then in step 640 the smart tag is evaluated by a context and relevancy analyzer, to identify the best content of smart tag in step 645, such as based on recent trends, bestseller lists, user history, etc. (e.g., identifying the book title, song title and artist, restaurant name as a nearby restaurant, etc.) Accordingly, in step 650, the server 120 may identify associated rich content for the smart tag content (e.g., book information and an online bookstore, song information and an online music store, restaurant information and an online review site, etc.).

Alternatively from step 635, for the scenario B text messages above without specific tagging, in step 655 it may be determined whether the message contains a supported verb, such as “eat”, “listen”, “read”, “watch”, “see”, etc. As such, in step 660, the context of the supported verb may be determined, such as determining that “read” is assigned to a Product>Book category, while “listen” is assigned to a Media>Music category and “eat” is assigned to a Restaurant category.

Accordingly, in step 665, content of the message may be identified based on the context of the supported verb from step 660. For example, “read” may result in locating “book-title” from a book-based product search, while “listen” may result in locating “song-title” from a music-based media search. Also, “eat” may determine that a key restaurant-based word “Italian” is located within the text message, which may result in looking up a list of local Italian restaurants or entering “Italian” into a restaurant-based search. Assuming each of these contents can be located, the procedure 600 returns to step 650 to identify the associated rich content for the identified message content using the supported verb rather than the explicitly marked/tagged content.

The procedure 600 illustratively proceeds to step 670 in FIG. 6B, where smart text data (e.g., JavaScript Object Notation or “JSON” data) is prepared for the rich content, which may then be passed to the sender and receiver in step 675. Once received, the sender's and receiver's client prepare the smart text data for display as rich content in step 680 as described herein. Notably, (and optionally prior to the receiver receiving the smart text data), the rich content may be confirmed with the sender in step 685, such as to reduce multiple results to single choice (e.g., multiple songs with the same title, multiple Italian restaurants nearby, etc.), or to narrow the rich content displayed in general (e.g., book product pages, not book review pages).

In step 690, the receiver, having now received the rich content, may perform various actions presented by that rich content. For example, in the book scenarios, the receiver may read a review of the book, and/or may purchase the book from an online bookseller via an internal browser on their device by clicking on (selecting) the rich content. Alternatively, for the song scenarios, the receiver my be given the option to listen to the song (or a preview of the song), and may have another option to buy the song from an online music store, which may be performed within an associated web-site linked through the rich content, or else may cause the directed launch of an associated app on the receiver's device (e.g., a music-store app launched to the option of purchasing the shared song-title). Lastly, for the restaurant scenario, the receiver may be given the option to view the ratings of a selected set of nearby Italian restaurants. From there, or alternatively as s first choice, the receiver may be given the option to view the restaurants on a map and/or obtain directions to a selected restaurant from the list.

The procedure 600 illustratively ends in step 695, though with the option to further define the rich content, add new rich content based on the flow of the text communication between the sender and receiver, etc. Notably, the steps shown above in FIGS. 6A-6B are meant as an example, and are not meant to be limiting to the scope of the embodiments herein. Moreover, it should be noted that while certain steps within procedures 300 and 600 may be optional as described above, the steps shown in FIG. 3 and FIGS. 6A-6B are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 300 and 600 are described separately, certain steps from each procedure may be incorporated into each other procedure, and the procedures are not meant to be mutually exclusive.

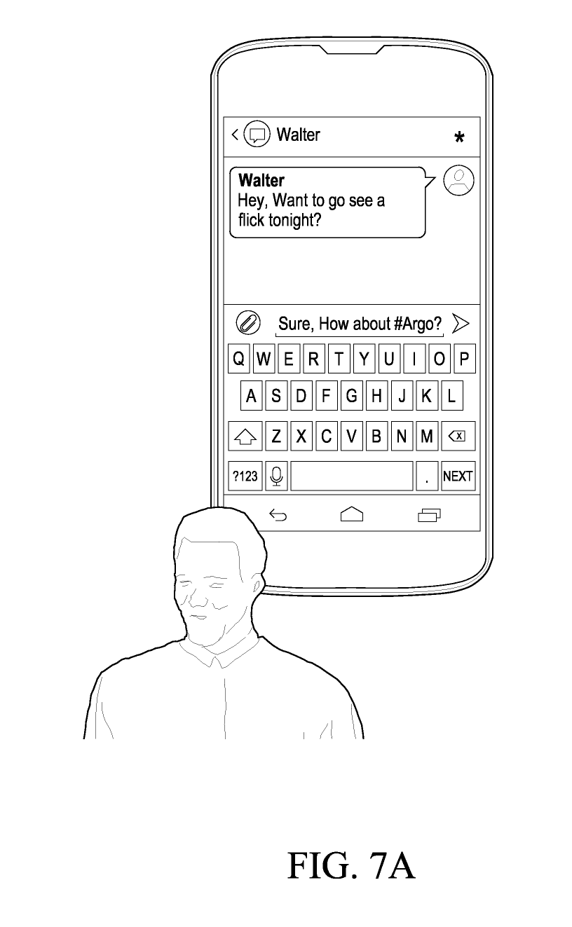

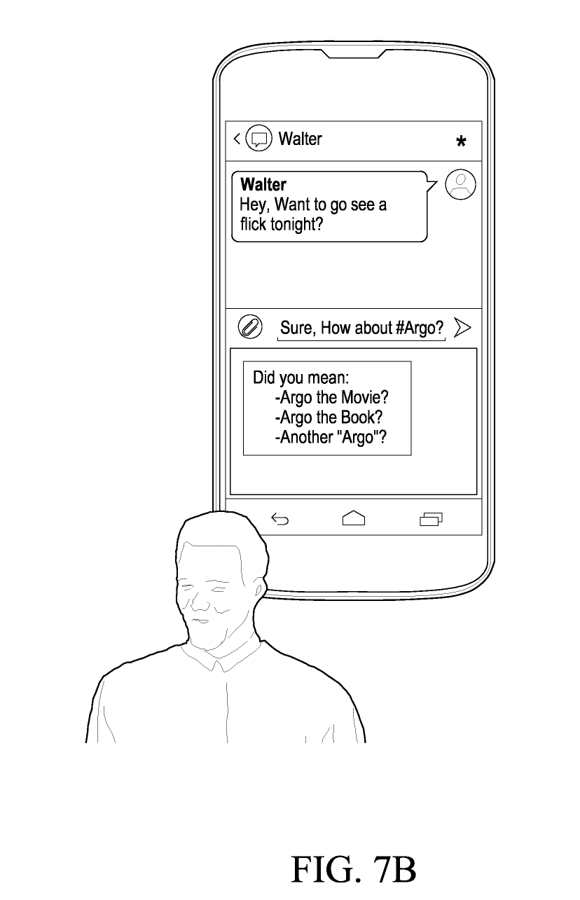

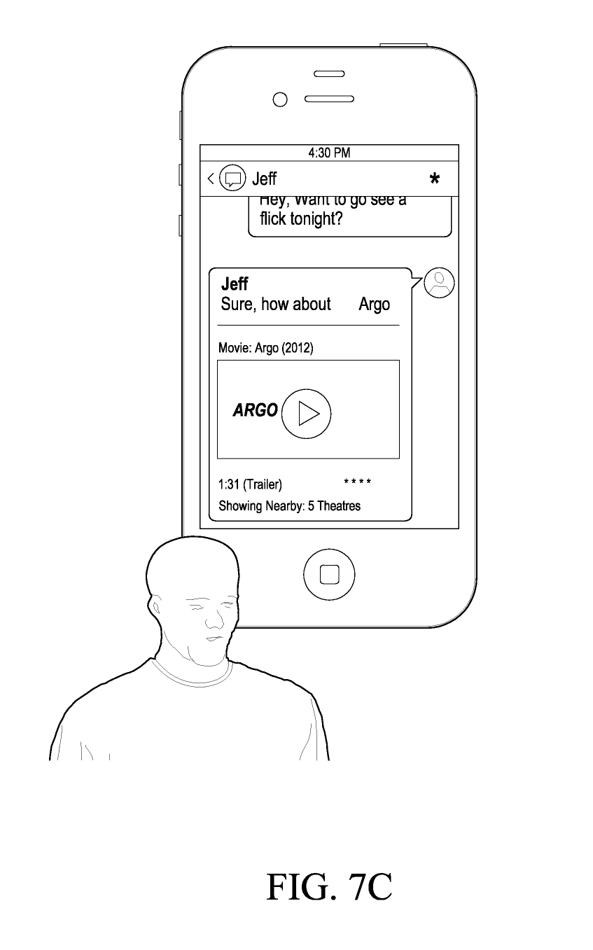

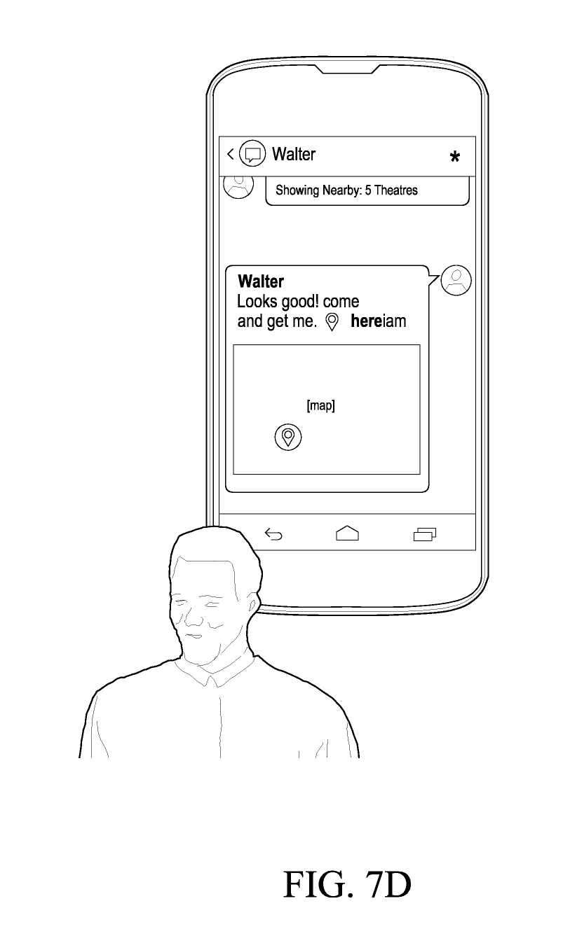

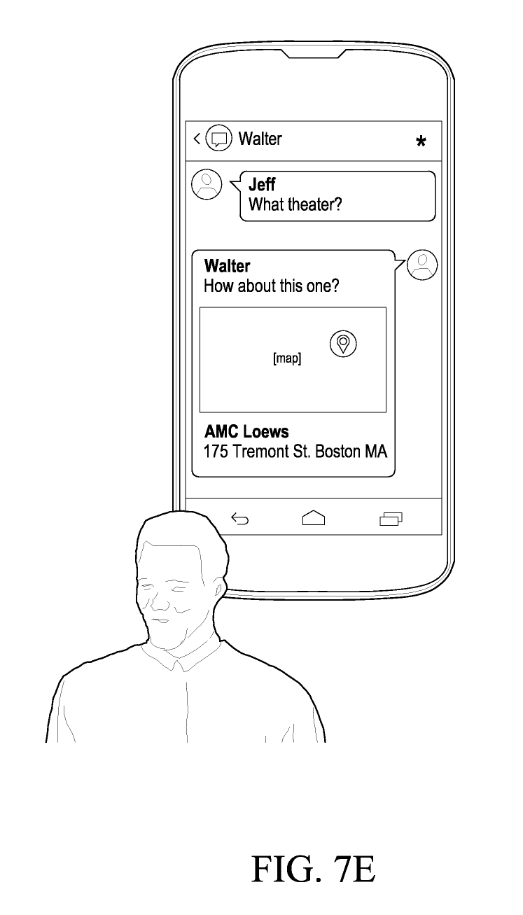

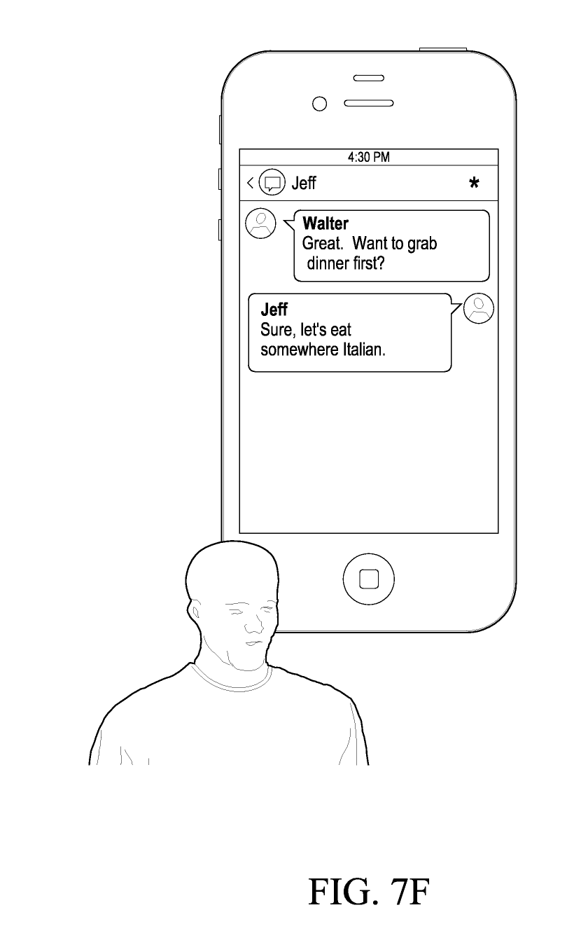

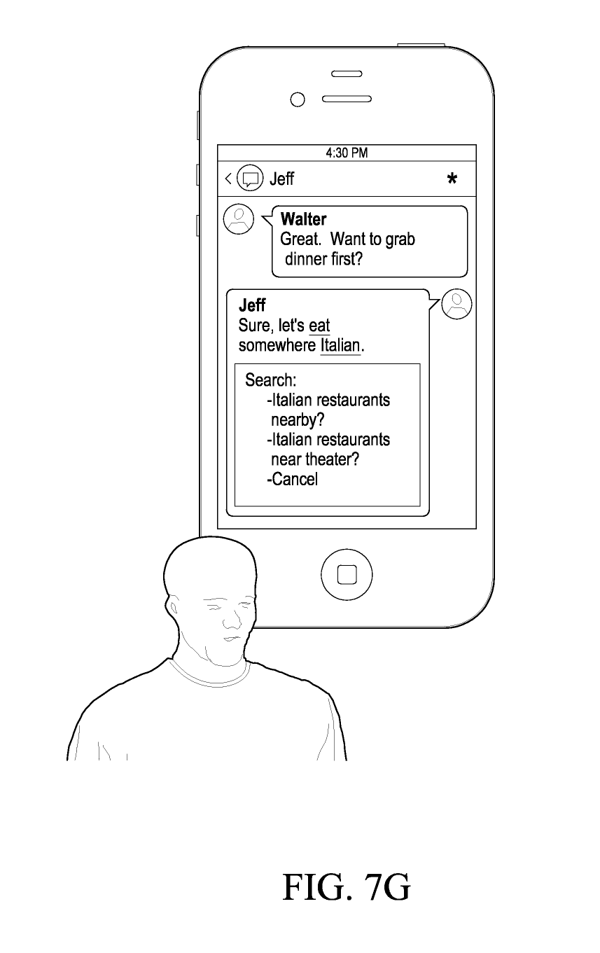

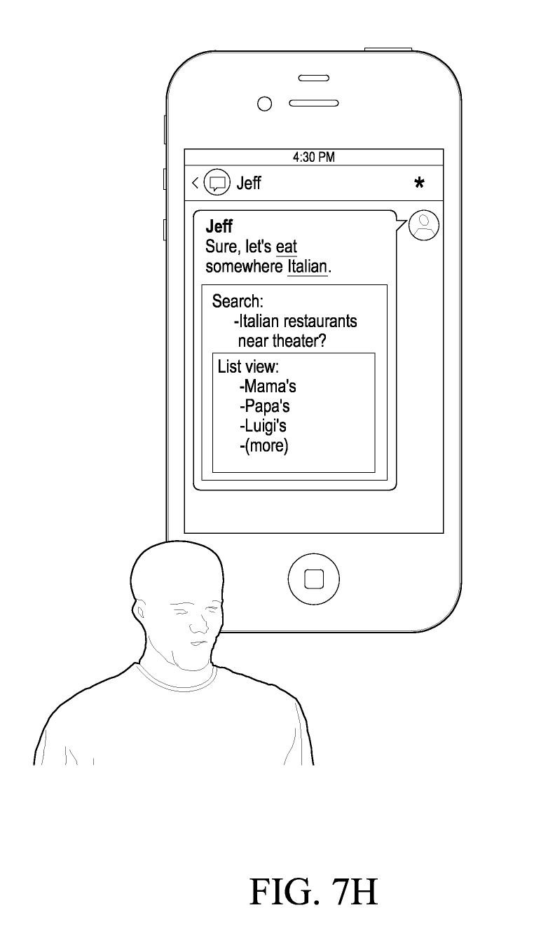

FIGS. 7A-7H illustrate an example of an enhanced text messaging service communication in accordance with the techniques herein (notably as a non-limiting specific implementation). In particular, assume a conversation between two friends, Walter and Jeff, as initiated by Walter in FIG. 7A. For instance, Walter texts to Jeff “Hey, want to go see a flick tonight?” In response, Jeff is shown replying with “Sure, how about #Argo?” Based on the smart tagging of “Argo” (or other detection triggers as described herein), the techniques herein may then detect the tagged content, and may request from the sender a clarification of the desired context, such as if other clues were not present (e.g., “the movie #Argo” rather than just “#Argo”). As such, as shown in FIG. 7B, Jeff, the sender, is asked whether he meant the movie, the book, or other context. Once selecting the movie, Jeff and Walter may now be shown a preconfigured movie panel as shown in FIG. 7C, showing the title, a video clip (e.g., trailer), a star rating, and a link to nearby theaters showing the desired movie. Notably, once selected as a movie, the smart tag may also graphically change to a corresponding icon, such as a movie camera in this instance as shown.

If Walter is interested, he may respond as shown in FIG. 7D with “Looks good! Come and get me. #hereiam”, where the tagged use of a recognized/reserved term “hereiam” results in a mapped display of Walter's current geo-location.

Continuing the conversation, as shown in FIG. 7E, if Jeff asks “what theater?”, then Walter may be able to respond by clicking the link to nearby theaters shown in FIG. 7C above, and then based on location, local knowledge, movie times, etc., may share a desired movie theater location. Then in FIG. 7F, Jeff replies: “Great. Want to grab dinner first?” Then Walter says, “Sure, let's eat somewhere Italian.” According to the techniques herein, even though Walter did not tag “Italian,” the system may detect the keyword “eat” and place it in context with the word “Italian.” As such, as shown in FIG. 7G, Walter may be presented with Italian restaurant options nearby, near the intended destination (e.g., near the known movie theater), or else to cancel the selection, since there was no explicit tagging performed by Walter. As shown in FIG. 7H, if a selection is made, then a list or map of Italian restaurants may be presented and shared with Jeff as a list, or perhaps one individual restaurant may be selected and shared, and so on.

Advantageously, as illustrated with the example in FIGS. 7A-7H, the techniques herein provide an enhanced text messaging service between to client devices. For instance, the techniques engage the communicators in a more compelling messaging experience, and open standard text messaging into a fully integrated online experience. In particular, the techniques herein saved the communicators above from having to surf the web manually, or from using multiple different apps, by using the intelligent text tagging described above. Other features may be readily available to the communicators as well, such as being able to purchase tickets for the movie, reserve a table at the restaurant, etc., depending upon their selections, app configuration, app integration, etc. For example, assume that a first user asks a second user for a recommendation on a product, such as a digital camera. The second user may then use the smart-tagging to tag a particular style of digital camera, which could pull up various options (relevant search results) related to that tagged camera. The second user may select the intended camera, and sends the rich content to the first user, who may then view the details, purchase the camera, add the camera to a third-party wish-list, etc.

While there have been shown and described illustrative embodiments that provide for an enhanced text messaging service, it is to be understood that various other adaptations and modifications may be made within the spirit and scope of the embodiments herein. For example, the embodiments have been shown and described herein with relation to cellular networks in general. However, the embodiments in their broader sense are not as limited, and may, in fact, be used with other types of communication/messaging networks and/or protocols.

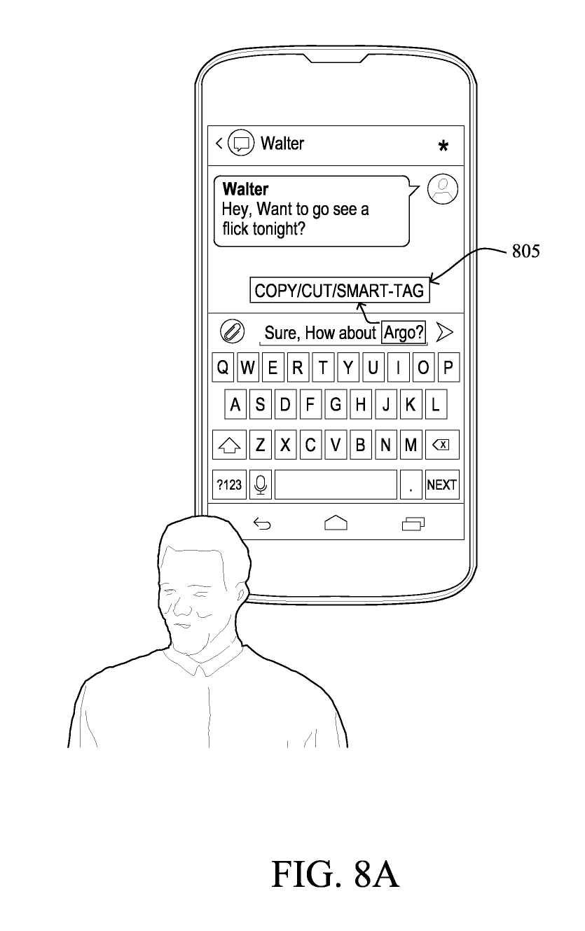

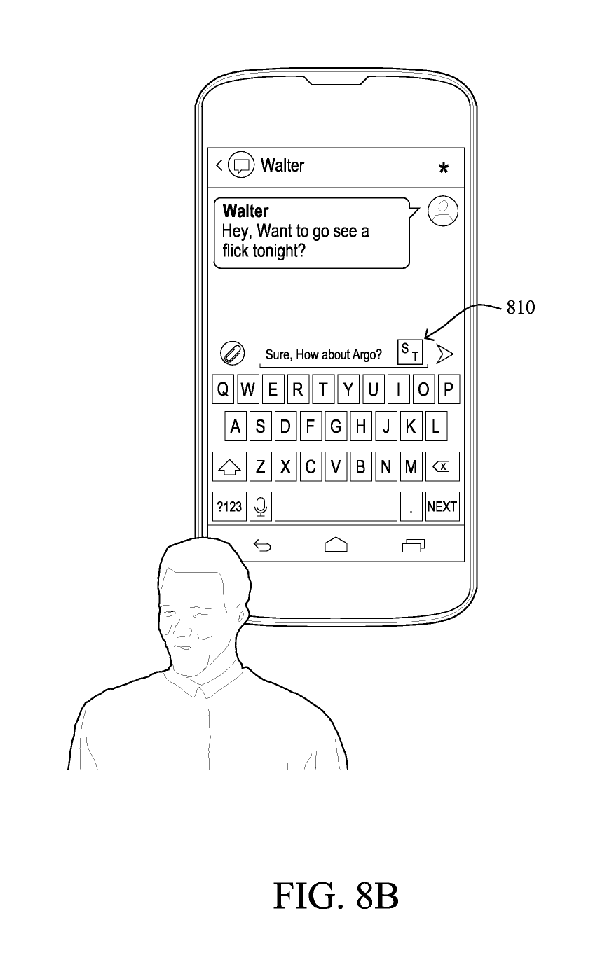

In addition, for instance, FIGS. 8A-8B illustrate further examples of how detection of specific content within a text message may be triggered, such as in response to user action selection. For example, as shown in FIG. 8A, a selected text option may be added to conventional options (e.g., “copy/cut/etc.”), such as a “smart tag” option 805, which may either specifically categorize the selected text as detectable content, or else may add the designed identifying/tagging characters to either or both ends of the selected word/words. Alternatively, a similar user action is shown in FIG. 8B, where a user may select a specific button/icon 810, which may either add an identifying/tagging character (inside the text where the cursor is at the time of selection or else appended to the end(s) of selected text), or else starts (and stops) specific categorization of the word(s) currently being entered as detectable content.

Further alternative embodiments may also be available, such as providing the above enhanced features in response to entering a basic text messaging service through an enhanced feature enabling application (e.g., clicking a first app that redirects the user to a basic text messaging app, though now with enabled enhanced features). In other words, the techniques herein may be configured to execute within an application separate from a text messaging application on the user's device (in which the text messages are drafted).

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
detecting identified content within a text message;
calling up sender selection of rich content associated with the identified content in response to detecting the identified content; and
embedding the selected rich content into the text message.

2. The method as in claim 1, wherein detecting comprises:
detecting an identifying character for tagged content.

3. The method as in claim 1, wherein detecting comprises:
identifying content based on one or more of keywords and contextual words.

4. The method as in claim 1, wherein detecting comprises:
detecting one or more reserved words having special meaning for detection.

5. The method as in claim 4, wherein the one or more reserved words correspond to providing one or more of a current geo-location and a current venue of a text message drafter.

6. The method as in claim 1, wherein detecting is in response to user action selection.

7. The method as in claim 6, wherein user action selection is selected from either a selected text option or a selectable icon.

8. The method as in claim 1, wherein calling up occurs during composition of the text message.

9. The method as in claim 1, wherein calling up occurs in response to sending of the text message, and wherein embedding occurs as an appending to the text message.

10. The method as in claim 1, wherein embedding comprises:
embedding the rich content as one of either a hyperlink to the rich content and associated with the identified content or a separately appended uniform resource locator (URL) to the rich content.

11. The method as in claim 1, wherein embedding comprises:
providing an embedded panel or display of the rich content.

12. The method as in claim 1, wherein calling up and embedding occur at a server in response to a text messaging device detecting the identified content during composition of the text message.

13. The method as in claim 1, wherein detecting, calling up, and embedding occur at a server in response to a text messaging device sending the text message to the server.

14. The method as in claim 1, wherein calling up comprises:
providing rich content options for user selection.

15. The method as in claim 14, wherein the rich content options request user confirmation from among options.

16. The method as in claim 1, wherein the rich content options are based on one or both of text message context and relevancy.

17. The method as in claim 1, wherein one or more of the detecting, calling up, and embedding are performed by an application separate from a text messaging application on a user device.

18. An apparatus, comprising:
one or more network interfaces;
a processor communicating with the one or more network interfaces and configured to execute processes; and
a memory configured to store a process executable by the processor, the process when executed operable to:
detect identified content within a text message;
call up sender selection of rich content associated with the identified content in response to detecting the identified content; and
embed the selected rich content into the text message.

19. The apparatus as in claim 18, wherein the process is configured to execute within an application separate from a text messaging application on the apparatus.

20. A tangible, non-transitory, computer-readable media having program instructions thereon, the program instructions when executed by a processor being configured to:
detect identified content within a text message;
call up sender selection of rich content associated with the identified content in response to detecting the identified content; and
embed the selected rich content into the text message.
